(19) United States
(12) Patent Application Publication
(10) Pub. No.: US 2010/0204840 A1
(43) Pub. Date: Aug. 12, 2010

(54) Modified Fuzzy Control for Chiller Electronic Expansion Valve

(75) Inventors: Wenzhe Sun, Shanghai (CN); Shufu Ding, Shanghai (CN); Weijiang Zhang, Shanghai (CN); Yongliang Hu, Shanghai (CN)

Correspondence Address: BACHMAN & LAPOINTE, P.C. (UTC), 900 CHAPEL STREET, SUITE 1201, NEW HAVEN, CT, 06510-2802, US

(73) Assignee: CARRIER CORPORATION, Farmington, CT (US)

(21) Appl. No.: 12/601,909

(22) PCT Filed: May 22, 2008
(86) PCT No.: PCT/US08/64442

§ 371 Date: Nov. 25, 2009

(30) Foreign Application Priority Data
May 25, 2007 (CN) 200710104557.X

(51) Int. Cl. G05D 23/19; G05D 7/06

(52) U.S. Cl. 700/282; 700/300

(57) ABSTRACT

Methods and systems are described for controlling an expansion valve in large chiller refrigerant loops that employ a modified fuzzy logic control system that modulates an electric expansion valve for controlling cooling capacity.

### BACKGROUND OF THE INVENTION

The invention relates generally to the field of chiller control systems. More specifically, embodiments of the invention relate to methods and systems that control the cooling capacity of water chiller systems.

In water chiller systems, water is chilled in an evaporator to provide a cooling medium for air conditioning use elsewhere. The chilled water can then be piped to an air handler by a first water loop. The air handler exchanges heat between circulated air and the chilled water, conditioning the air for use in a zone or building.

The evaporator in a water chiller system typically controls the temperature of the water by heat exchange with refrigerant. The refrigerant circulates throughout the chiller system by means of a refrigerant loop. In the refrigerant loop, the refrigerant leaves the evaporator and enters a compressor where the pressure of the refrigerant is increased, changing its condensation point. The compressed refrigerant leaves the compressor and enters a condenser where it is condensed from a vapor to a liquid refrigerant by heat exchange with a cooling medium, typically a second water system. The liquid refrigerant is then returned, by means of an expansion device, to the evaporator to continue the cycle through the refrigerant loop.

The expansion device is usually an electronic valve which modulates refrigerant flow in response to refrigerant superheat as measured before the refrigerant enters the compressor. A thermal expansion valve controls the rate at which liquid refrigerant can flow into the evaporator. This is accomplished by use of a temperature sensing device that causes the valve to open or close as temperature changes in the evaporator. The compressor capacity is modulated in response to the leaving water temperature of the evaporator.

Due to the different thermodynamic characteristics of HFC-134a (R-134a) which is a refrigerant without an ozone depleting potential, a higher stability of suction pressure is required than when using HCFC-22 (R-22). A traditional proportional regulation thermodynamic expansion valve (TXV) is not suitable for highly non-linear and large lag refrigerant systems. Due to the non-linear behavior, there will be a large control response delay when using HFC-134a in screw compressor chillers. A large refrigerant charge, use of four-way valves to switch between heating and cooling modes, and an accumulator at the chiller compressor low-pressure side challenges control of the expansion valve when a traditional PID (proportional-integral-derivative) controller is used.

PID control does not offer the best control during different dynamic processes since it is optimized for one process. For example, it is difficult to optimize PID parameters (the gains of the proportional, integral and derivative terms) for different process modes such as chiller system start-up, defrosting or normal heating. The PID parameters optimized for one process may not be optimal for another. A control system may require different parameters during system start-up and steady state operation. If the PID parameters are incorrect, its output can become unstable resulting in oscillation or process runaway.

An electrically modulating expansion valve (EXV) allows for control algorithms other than PID control to be used such as fuzzy logic. However, when superheat error is relatively large, fuzzy control may not react as quickly as PID control to reduce the superheat error quickly.

What is desired is a control strategy that addresses the need for control stability and fast response.

### SUMMARY OF THE INVENTION

The inventors have discovered that it would be desirable to have methods and systems that employ a fuzzy logic controller in conjunction with predetermined ranges and control strategies to modulate an electric expansion valve for controlling the cooling capacity of large screw compressor chillers. The compressor expansion valve controller comprises a fuzzy logic controller in conjunction with an override control. The override control is comprised of several process error regions which provide hard outputs, a calculated output and a scaled fuzzy logic output. Fuzzy control is used during small process errors and override control for larger process errors. If the superheat error is within approximately ±6° C. around setpoint, fuzzy control is employed. If the superheat error becomes greater, override control is used.

One aspect of the invention is a method for controlling a modulating expansion valve for a chiller. Methods according to this aspect start with inputting a chiller superheat value, deriving a superheat error, comparing the superheat error against a plurality of superheat error tests wherein each superheat error test defines an operating region, for each operating region, calculating a control action based on the superheat error, and outputting a control variable corresponding with a corresponding control action to modulate the expansion valve and minimize the superheat error.

Another aspect of the invention is a controller for controlling a chiller modulating expansion valve. Controllers according to this aspect comprise an input configured to accept a superheat measurement signal, a process setpoint input defining a chiller superheat operating point and configured to output a superheat error, an error test coupled to the superheat error, the error test configured to determined if the superheat error is within one of a plurality of predefined operating regions, and a control action associated with each operating region wherein, the error test couples the superheat error to an associated control action to modulate the opening of the expansion valve to minimize the superheat error.

Another aspect of the invention is a controller for controlling a modulating expansion valve for a chiller. Controllers according to this aspect comprise a processor configured for inputting a chiller superheat value, deriving a superheat error, comparing the superheat error against a plurality of superheat error tests wherein each superheat error test defines an operating region, for each operating region, calculating a control action based on the superheat error, and outputting a control variable corresponding with a corresponding control action to modulate the expansion valve and minimize the superheat error.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a piping and instrument diagram of an exemplary water chiller system.

FIG. 2 is an exemplary control system diagram of the expansion valve controller.

FIG. 3A is an exemplary membership function for the error x(t).

FIG. 3B is an exemplary membership function for the error rate-of-change

$$\frac{d x ( t )}{d t} .$$

FIG. 4 is an exemplary fuzzy logic rules matrix.

FIGS. 5A and 5B are plots comparing a response of a PID controller with an embodiment of the invention to the same system and system perturbation.

FIGS. 6A, 6B and 6C are plots comparing the use of a PID controller with an embodiment of the invention in response to the system perturbation shown in FIG. 5A.

### DETAILED DESCRIPTION

Embodiments of the invention will be described with reference to the accompanying drawing figures wherein like numbers represent like elements throughout. Further, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. The terms “mounted,” “connected,” and “coupled” are used broadly and encompass both direct and indirect mounting, connecting, and coupling. Further, “connected” and “coupled” are not restricted to physical or mechanical connections or couplings.

The invention is not limited to any particular software language described or implied in the figures. A variety of alternative software languages may be used for implementation of the invention. Some components and items are illustrated and described as if they were hardware elements, as is common practice within the art. However, various components in the method and system may be implemented in software or hardware.

Embodiments of the invention provide methods, systems, and a computer-usable medium storing computer-readable instructions for a screw compressor expansion valve controller. The controller comprises a fuzzy logic controller in conjunction with predetermined error range outputs. The invention may be deployed as hardware resident in an enclosure having an onboard power supply, or as software as an application program tangibly embodied on a program storage device for executing with a computer, processor, programmable logic controller (PLC) and the like. The application code for execution may reside on a plurality of different types of computer readable media.

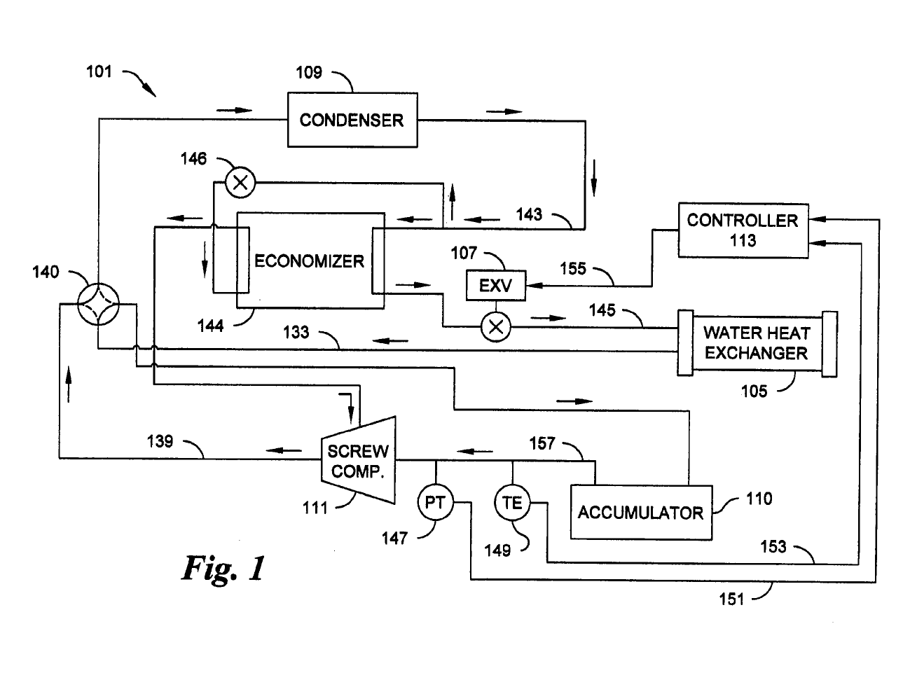

Shown in FIG. 1 is a typical chiller system 101 which uses a refrigerant loop to provide chilled water for air conditioning purposes. The chiller system 101 has a refrigerant loop that comprises an evaporator 105, an expansion valve 107, a condenser 109, an accumulator 110 and a compressor 111. The system 101 is controlled by a controller 113 which may be a computer, processor, programmable logic controller (PLC) or other.

The evaporator 105 uses refrigerant provided to it by the expansion valve 107 to condition water in a heat exchanger. The entering water is provided by a conduit (not shown). The water leaving the evaporator 105 is referred to as leaving water. The chilled leaving water is placed in heat exchange relationship in an air handler with air that is then provided to zones or buildings for air conditioning purposes by means of ducts.

The refrigerant in the evaporator 105 has been vaporized during the heat exchange with the water. As part of the refrigerant loop, the vaporous refrigerant leaves the evaporator 105 and is directed to the compressor 111 by a passage 133. In the compressor 111 the refrigerant is compressed so that its condensation point is lowered.

The compressed refrigerant leaves the compressor 111 and is directed by a passage 139 to the condenser 109 via a four-way valve 140. In the condenser 109, a cooling medium such as a second water loop (not shown) condenses the compressed vaporous refrigerant to a liquid. The condensed liquid refrigerant is then returned to the evaporator 105 by means of a passage 143, through an economizer 144 and economizer valve 146, and through the expansion valve 107 and a passage 145.

Refrigerant superheat is the difference between saturation refrigerant vapor temperature as measured by a pressure transmitter 147 and refrigerant liquid temperature as measured by a temperature element 149 located in the passage 157.

superheat=compressor suction temp−compressor saturated suction temp (1)

The pressure transmitter 147 may be any type, such as a capacitance cell, and the temperature element 149 may be a thermocouple, an RTD (resistance temperature detector), or others.

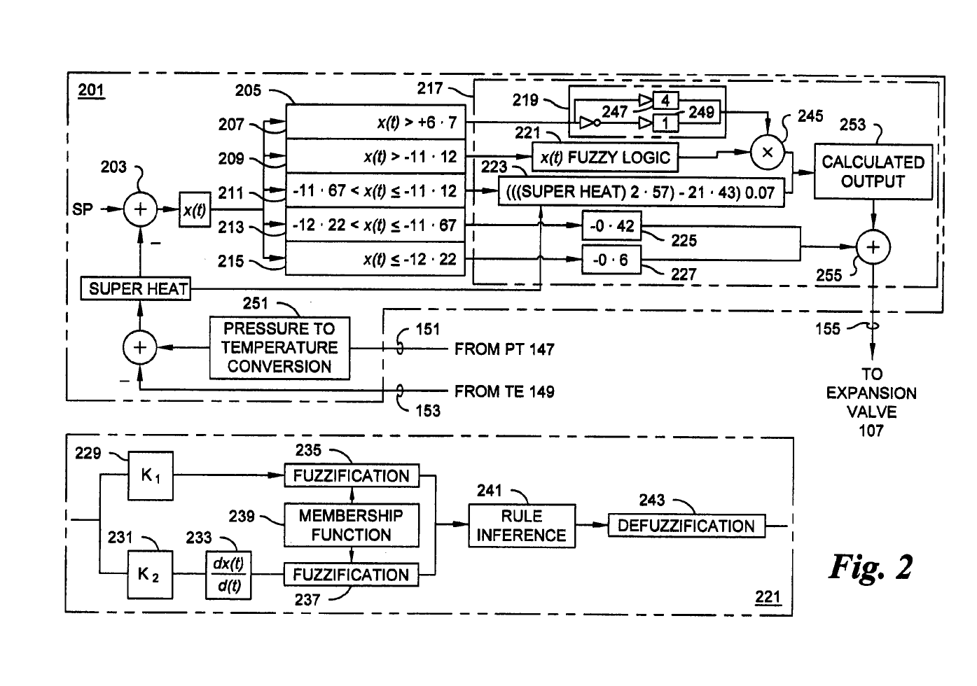

Shown in FIG. 2 is the expansion valve controller 201. The controller 201 may be part of the chiller control system 113 or may be in a separate enclosure. The signals output by the compressor suction gas pressure transmitter 147 and temperature element 149 are coupled to the controller 201 via electrical connections 151, 153.

Compressor suction pressure is used to derive refrigerant saturation temperature. Refrigerant saturation temperature is the pressure-temperature when the refrigerant is turning from a low pressure liquid to a low pressure vapor (absorbing heat). At saturation pressure-temperature, both liquid and vapor are at the same temperature. The measurement from pressure transmitter 147 is converted 251 to saturation refrigerant vapor temperature in the controller 201 using a pressure/temperature curve or pressure/enthalpy curve corresponding to the type of refrigerant gas used in the system 101. The saturated temperature (from temperature element 149) and the suction temperature (from pressure transmitter 147) are compared and the difference is the amount the refrigerant gas has heated past saturated temperature. This is superheat (1).

The superheat (1) is used to modulate the amount of refrigerant passing through the expansion valve 107. An embodiment of the invention controls the expansion valve 107 via an electrical connection 155 from the controller 201. The control of the chiller compressor capacity involves modulating the expansion valve 107 in response to changes in superheat (1).

Embodiments of the invention use fuzzy logic control in conjunction with an override control to improve compressor control stability. The override control is used when the superheat error is outside of a predefined range.

The controller 201 comprises a setpoint 203, where a process error x(t) is obtained from the difference between the process variable (PV) (superheat) and a setpoint value (SP), an error test 205 comprising error x(t) tests 207, 209, 211, 213, 215 for determining control operating regions and corresponding control actions 217. The controller 201 output is coupled to the expansion valve 107 via electrical connection 155.

The error tests 207, 209, 211, 213, 215 for the process error x(t) are defined as

x(t)>+6.7 207,

x(t)>−11.12 209,

−11.67<x(t)≦−b 11.12 211,

−12.22<x(t)≦−11.67 213, and

x(t)≦−12.22 215.

The range values represent an error in ° C. from setpoint and may be modified accordingly. For example, if the process setpoint SP is 15° C., a normal operating region 209 would be active corresponding to superheat temperatures greater than 3.88° C. (x(t)=−11.12° C.) to 21.7° C. (x(t)=+6.7° C.). The outputs of the error tests 205 are coupled to corresponding control actions 217 which comprise a multiplier value 219, a fuzzy logic controller 221, a variable superheat relationship 223, and two hard output corrections 225, 227. As can be seen, depending on the value of the process error x(t), a different control action for the expansion valve 107 will be derived and employed.

For chiller operation absent any large system perturbations, the normal operating region 209 uses a fuzzy logic controller 221 to control the expansion valve 107 in response to the process variable error. The fuzzy controller 221 comprises first 229 and second 231 signal conditioners, a differentiator 233, error x(t) 235 and derivative of the error

$$\frac{d x ( t )}{d t}$$

237 membership functions 239, a rule inference module 241, and a defuzzification module 243.

Fuzzy logic is able to deal with imprecise inputs, such as linguistic descriptions, to define a relationship between input information and output action. Fuzzy logic uses heuristics such as if <condition> then <action> logical implications. Rules associate conclusions with conditions similar to constructing a table of inputs and corresponding output values, but instead of having crisp numeric values of input and output variables, fuzzy values are used. A connection between condition and consequence is made by reasoning which are expressed by the evaluation of inputs in order to draw a conclusion.

The rules of inference have the form if (A and B) then C, where A, B and C are linguistic variables. For example, if the error x(t) is “negative big,” and the error rate of change

$$\frac{d x ( t )}{d t}$$

is “positive big,” then “expansion valve control output is zero.”

The total number of rules describing the system equals N×M, where N is the number of subsets associated with the error x(t), and M is the number of subsets associated with the error derivative

$$\frac{d x ( t )}{d t} .$$

For the invention, N=M=5, producing a total of 25 rules.

The domain where the error x(t) (E) and the error derivative

$$\frac{d x ( t )}{d t} ( DE )$$

$$( DE = E - E ( 5 seconds ago ) )$$

inputs are evaluated may be divided into five subsets or memberships.

NB is negative big, and means E, DE or U is relatively big in a negative direction

NS is negative small, and means E, DE or U is relatively small in a negative direction

ZE is zero, and means E, DE or U is zero

PS is positive small, and means E, DE or U is relatively small in a positive direction

PB is positive big, it means E, DE or U is relatively big in a positive direction

The membership function is a graphic representation of the degree of membership of each input to a specific fuzzy subset. The number of membership functions associated with an input equals the number of fuzzy subsets (subdomains) defined for that particular input.

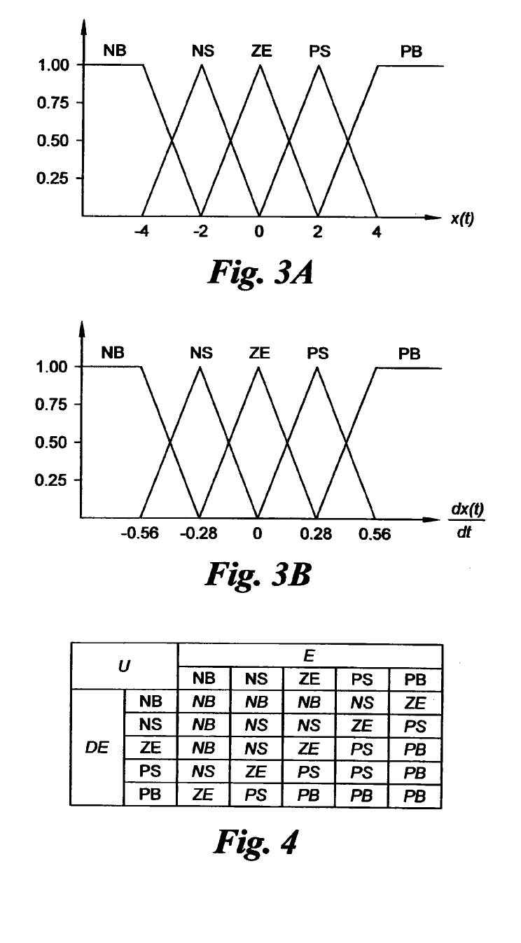

FIGS. 3A and 3B show a graphic representation of the five membership functions (NB,NS,ZE,PS,PB) associated with each subdomain, E and DE. The linguistic variable for the controller output is U. The membership functions for the input fuzzy sets negative small NS, zero ZE, positive small PS are triangular, and the membership functions for negative big NB and positive big PB are half triangular with shoulders indicating the physical limits for the process.

The fuzzy controller 221 evaluates the inputs E and DE using a set of rules corresponding to if (A and B) then C. The part of the rule delimited by “if” is the antecedent of the rule and refers to the status of the inputs. The part of the rule following “then” is the consequent and describes the status of the fuzzy output of the system. The consequent table for the fuzzy controller 211 is shown in FIG. 4.

A, B and C are logic sentences having in fuzzy logic a truth value between 0 and 1. The membership functions (FIGS. 3A and 3B) give the degree of membership within the set of any element. The membership function maps the elements onto numerical values in the interval [0, 1]. A membership function value of zero implies that the corresponding element is definitely not an element of the fuzzy set, while a value of unity means that the element fully belongs to the set. A grade of membership in between corresponds the input to a fuzzy membership set.

Each fuzzy membership spans a region of input values graphed with the membership. Any superheat error input is interpreted from this fuzzy set and a degree of membership is interpreted.

As described above, the process error x(t) is coupled to the error tests 207, 209, 211, 213, 215. If the error x(t) is above the value specified 209, the error signal passes through and is coupled to the first 229 and second 231 signal conditioners for adjusting signal levels if necessary. The output from the second signal conditioner 231 is coupled to the differentiator 233 for computing the error differential or error rate of change DE over time. The outputs of the first signal conditioner 229 and differentiator 233 are coupled to respective first 235 and second 237 fuzzification (membership) modules. The fuzzification modules 235, 237 convert the crisp input variables E and DE into a set space in accordance with the membership functions shown in FIGS. 3A and 3B.

Each error input, E and DE, after fuzzification, is processed by the rule inference module 241 where output decisions are performed. The inference process combines the rules in order obtain defuzzification. Defuzzification 243 assigns a crisp value as an output based on the inputs E and DE at a discrete time.

Several inference methods have been developed, the simplest being the Min-Max algorithm. A preferred embodiment uses the center-of-gravity method.

In order to convert a linguistic term into a computational framework, the fundamentals of set theory are employed. On the statement if “error” is negative big, the question “is the error negative big” must be answered. The idea of membership of an element x in a set A is a function μA(x) whose value indicates if that element belongs to the set A. Boolean logic would indicate, for example: μA(x)=1, then the element belongs to set A, or μA(x)=0, the element does not belong to set A.

For example, if μNS(E)=0.2, μZE(E)=0.8, μPS(DE)=0.4, and μPB(DE)=0.6, then μZE(U)=0.2, μPS(U)=0.4, μPS(U)=0.2, μPB(DE)=0.6 (the membership of output variable U is the minimum of the input variables E and DE). Using the center-of-gravity method, the fuzzy output would be

$$\begin{matrix}\frac{\begin{matrix}μ ZE ( U ) * ZE + μ PS ( U ) * PS + \\ μ PS ( U ) * PS + μ PB ( U ) * PB\end{matrix}}{μ ZE ( U ) + μ PS ( U ) + μ PS ( U ) + μ PB ( U )} = & ( 2 ) \\ \frac{\begin{matrix}0.2 * 0 + 0.4 * 0.12 + \\ 0.2 * 0.12 + 0.6 * 0.24\end{matrix}}{0.2 + 0.4 + 0.2 + 0.6} = 0.154 & ( 3 )\end{matrix}$$

The output from defuzzification 243 is coupled to a multiplier 245 that is associated with the high error test 207.

If the process error x(t) is greater than a predefined error 209, the fuzzy logic controller 221 provides the control action for the expansion valve 107. If the process error x(t) is greater than a predefined high error 207, the fuzzy logic controller 221 calculates a fuzzy control response for that error which is multiplied or scaled by a predetermined value 247 corresponding to the high error test 207. For the exemplary embodiment, the predetermined value is 4. If the high error is not experienced 207, a value 249 of 1 is multiplied 245 with the fuzzy logic controller 221 output.

For process errors x(t) less than or equal to the normal error 209, three low error ranges 211, 213, 215 are defined. For a low error range 211 defined by upper and lower limits, the measured superheat (1) is used and scaled (2.57), and a constant (21.43) is subtracted from the product. The difference is further scaled (0.07) and output as the calculated control action 253 for the expansion valve 107.

If the process error x(t) is less than or equal to the low error range 211 lower limit, the error is in a low-low range 213. A first predetermined correction 225 is summed 255 with the previously calculated control action 253. For the exemplary embodiment, the first correction value 225 is −0.42%. For example, if the previous calculated output 253 was 40% corresponding to expansion valve position, the output is reduced by −0.42%. The controller 201 output 155 would be 39.58%.

If the process error x(t) is less than or equal to the low-low error range 213 lower limit, the error is in a low-low-low range 215. A second predetermined correction 227 is summed 255 with the previous calculated control action 253. For the exemplary embodiment, the second correction value 227 is −0.6%.

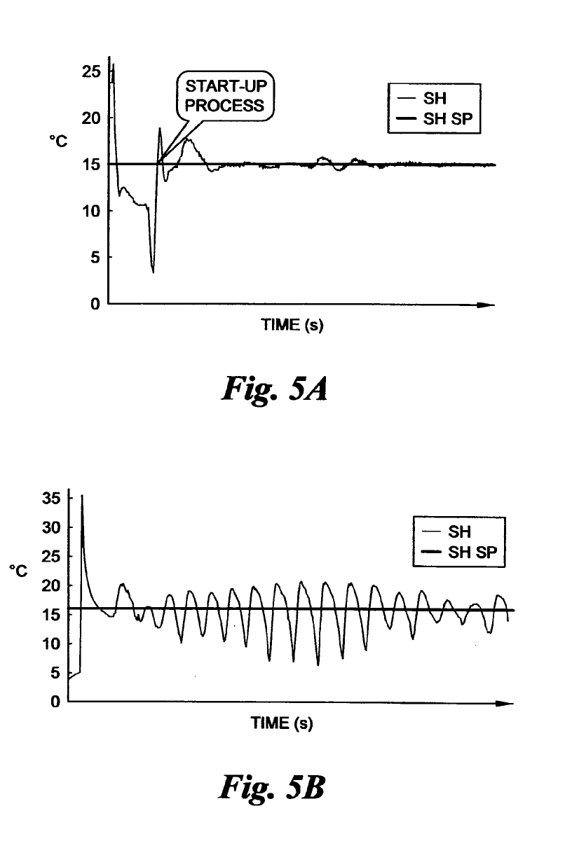

Shown in FIG. 5A is a plot of the response of the expansion valve 107 controller 201 during chiller startup. FIG. 5B is for the same system, but using a conventional PID controller. During startup, superheat experiences a very large fluctuation. For example, if the measured superheat is very high (23° C.), the rate of change will also experience large fluctuations, manifesting long term openings and closings for the expansion valve 107 if PID control is used. The expansion valve 107 response is more related to the control method than poor controller tuning.

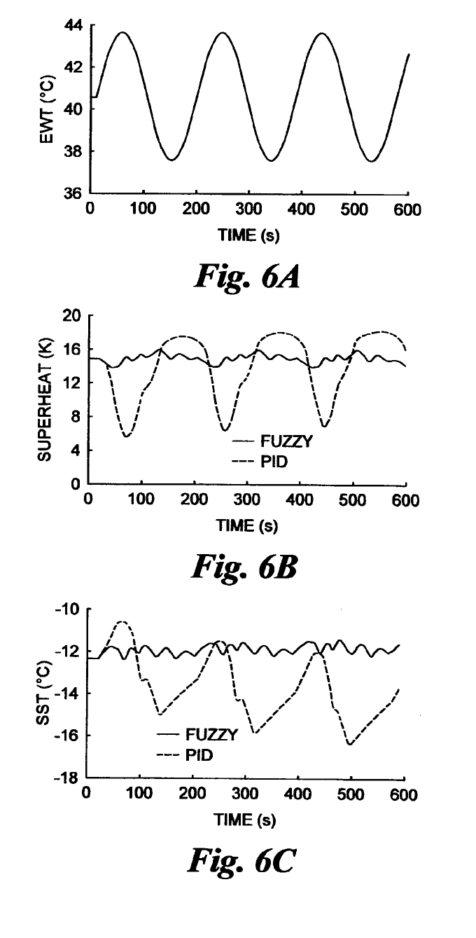

A mathematical model of the controller 201 was used to predict system transients under different system perturbations such as waving of entering water temperature and on/off operation of fans. The system perturbation (exiting water temperature) shown in FIG. 6A, and the comparisons between conventional PID control and fuzzy control for resultant superheat as shown in FIG. 6B and saturated suction temperature (SST) as shown in FIG. 6C. Heat exchanger models are developed based on mass, energy and momentum conservation equations. The compressor model and valve model are semi-empirical. The component models are coupled and integrated together and the whole system model is built. The program and case study are implemented in Dymola, a general dynamic modeling environment. The overall performance of PID logic and fuzzy logic is compared based on such a qualitative case when deciding controller development strategy.

Modeling (control simulation) is used to generate fuzzy control parameters to avoid system instability when tuning empirically. Tuning is performed based on transient modeling to determine the best fuzzy logic parameters. The control response within the upper and lower limit setpoints depends on the interval length of the fuzzy domain both in modeling and online testing. The range interval length is used as the tuning parameter instead of the membership function shape and is used as the tuned parameter. Range interval is the interval between membership functions. The membership functions employed in the invention are symmetrical, however, other shapes may be used.

With a stable expansion valve 107 control, heating and defrosting processes are simplified extending a chiller's operational envelope from about −10° C. to −15° C. A chiller may operate when outside temperatures are approximately −10° C. If the expansion valve 107 controller 201 can control superheat stably, suction pressure will also be stable even if the outside ambient temperature is very low (−15° C.). Normally, when the outside temperature is approximately −12° C., the suction pressure temperature is approximately −23° C. which is close to a typical alarm threshold of −26° C. Unstable expansion valve control will likely cause a unit trip on a low suction pressure alarm.

One or more embodiments of the present invention have been described. Nevertheless, it will be understood that various modifications may be made without departing from the spirit and scope of the invention. Accordingly, other embodiments are within the scope of the following claims.

What is claimed is:

1. A method for controlling a modulating expansion valve for a chiller comprising:
inputting a chiller superheat value;
deriving a superheat error;
comparing the superheat error against a plurality of superheat error tests wherein each superheat error test defines an operating region;
for each operating region, calculating a control action based on the superheat error; and
outputting a control variable corresponding with a corresponding control action to modulate the expansion valve and minimize the superheat error.

2. The method according to claim 1 wherein the plurality of operating regions include a normal operating region.

3. The method according to claim 2 wherein the normal operating region control action is fuzzy logic.

4. The method according to claim 3 wherein the fuzzy logic control action employs five membership functions.

5. The method according to claim 1 wherein superheat is defined as the difference between compressor suction temperature and compressor saturated suction temperature.

6. A controller for controlling a chiller modulating expansion valve comprising:
an input configured to accept a superheat measurement signal;
a process setpoint input defining a chiller superheat operating point and configured to output a superheat error;
an error test coupled to the superheat error, the error test configured to determined if the superheat error is within one of a plurality of predefined operating regions; and
a control action associated with each operating region wherein, the error test couples the superheat error to an associated control action to modulate the opening of the expansion valve to minimize the superheat error.

7. The controller according to claim 6 wherein one of the operating regions is a normal operating region.

8. The controller according to claim 7 wherein the control action for the normal operating region is performed using fuzzy logic.

9. A controller for controlling a modulating expansion valve for a chiller comprising:
a processor configured for:
inputting a chiller superheat value;
deriving a superheat error;
comparing the superheat error against a plurality of superheat error tests wherein each superheat error test defines an operating region;
for each operating region, calculating a control action based on the superheat error; and
outputting a control variable corresponding with a corresponding control action to modulate the expansion valve and minimize the superheat error.
